(19) United States
(12) Patent Application Publication
(10) Pub. No.: US 2015/0069215 A1
(43) Pub. Date: Mar. 12, 2015

(54) Baking Pan Insert

(71) Applicant: Betty Kohnen, West Des Moines, IA (US)

(72) Inventor: Betty Kohnen, West Des Moines, IA (US)

(21) Appl. No.: 14/021,140

(22) Filed: Sep. 9, 2013

(51) Int. Cl. B29C 33/76

(52) U.S. Cl. CPC B29C 33/76; B29K 2905/02; B29K 2905/12; B29K 2909/08; B29L 2031/74
USPC 249/203

(57) ABSTRACT

An insert for a baking pan, a baking pan, and a method of baking where the insert is generally cruciform in shape and is positioned on, and not attached to, the base of said pan, generally with the join of the cross at generally the center of the pan.

### BACKGROUND OF THE INVENTION

1. Field of the Invention

This disclosure is related to the field of baking pans, specifically to baking pans with removable inserts to alter the baking profile.

2. Description of Related Art

The baking process utilizes a number of chemical reactions, usually which occur in the presence of heat, to alter a batter or other source food into an ultimate baked good. During baking, a variety of variables can alter the consistency and profile of a resultant baked good. The first is the source of heat. Baking generally occurs in an oven, a generally sealed or enclosed structure which is maintained at a specific heat to allow the heat to be imparted to the baked good.

One major issue in all baking is how the heat of the oven is transferred to the batter. It is generally impossible to contact all of the batter with the exact same radiant heat from the inside of the oven. The batter generally must rest on or be contained in a baking pan, sheet, or other structure that serves to hold it. This alters the source of heat depending on where the batter is in the pan. Further, the batter is baked by different processes depending on its relative position and the type of pan used.

An exterior surface of the batter, which is exposed to the air in the oven, will be baked by convection currents moving the heated air past the surface. This can be used to provide breads and certain other baked goods with particularly crispy crusts or surfaces. Further, certain kinds of ovens, referred to as convection ovens, are designed to enhance this effect and can utilize powerful fans or air movement devices to enhance the currents in the oven to increase the convection baking effects. These can be particularly useful where crispy effects are desired or where larger quantities of items are to be cooked simultaneously as the heat within the oven is often more uniform.

In most baked goods, particularly those from generally more liquid prebaked materials, however, 50% or less of the good is exposed directly to the air. Other surfaces will generally be in contact with a baking pan or sheet. The specific materials of the pan or sheet therefore greatly influence the baking profile of such products with metals, coated metals, glass, stone, and other materials being used to produce specific textures and profiles. As these surfaces absorb heat by conduction from the oven, provide heat to the batter by conduction, and the types of material can be very different conductors, the resultant bakery product at the edge of a pan can be quite different from the top or center.

Further, even while all the exterior surfaces of a baked good are exposed to either conductive heat from the pan or convective heat from the air, the interior of a baked good also generally needs to be heated. Generally, the interior of a baked good is heated through either heat transfer due to water evaporation into the interior of the good from water that was originally at the surface or through heat transfer from the exterior surfaces into the center.

The problem with many baked goods is that alteration in the heat profile of the oven and application of heat to the exterior via pan can dramatically alter the resultant textures and profiles of the good. Thin baked goods are much easier to bake and make crisp as they have very little internal area compared to that of the external area. In this way, the heat from the oven is generally directly applied and the baked good will rapidly heat all the way through. A particularly thick baked good, however, often requires cooking at a low, slow temperature to insure that the center is entirely cooked, while the exterior is not burned due to being exposed to too much heat. Further, some recipes (such as Baked Alaska) specifically rely on ineffective heat transfer to allow for different profiles to be maintained in different parts of the baked good.

It can be difficult to determine exactly how to cook any particular good without having utilized the same pan size, shape and material previously. For example, pans which are classified as “9×9” (meaning they are nine inches square) may have that dimension internally (as they are supposed to) or externally. A 9×9 pan with only one-quarter of an inch reduction in its dimensions due to manufacturing differences loses almost five square inches of air surface area and a batter which would have been an inch deep loses four square inches of pan contact. While this may not seem like a lot, it can cause a dramatic change in desired cooking times and temperatures. Failure to adapt to such changes in pan size (or material) can lead to an edge of the baked good that was chewy in a full sized-pan becoming hard and crunchy in the slightly smaller pan.

The problem with cooking effects is that the baking of a good is generally dictated by the time to get the center of the good “done.” Undercooked food can be dangerous and baked goods regularly contain products (such as eggs and other animal products) that need to be fully-cooked (that is reach a certain minimum temperature) to kill infectious organisms and be considered safe for human consumption. Thus, baking times are often approximated and the baker will use tests (such as whether a toothpick comes out clean) to determine if the product is actually “done.” When making a recipe for the first time, or in a different pan, this vaguery can lead to the edges becoming overdone unintentionally.

In certain types of baked goods there are also specific preferences to certain positions in the pan due to the differences in cooking caused by the interaction of convection, conduction, and internal heat transfer to produce different flavors and textures. Good examples include brownies, lasagna, and meatloaf. In these recipes, contact with the pan will often impart very different textures and flavors to parts of the exact same recipe that are not in contact with the pan. Thus, brownie batter that is in contact with an edge of the pan often cooks to a thick chewy consistency, while batter in the center of the pan can be more cake-like and spongier. Similarly a meatloaf's pan contacting surface will often have increased sugar caramelization which can lead to a richer flavor and more solid texture.

Trying to obtain these specialized effects (which are often desirable) can require additional accuracy in cooking temperatures and times and failure to correctly cook the center of the batter can lead to destruction of the desirable edge effects to complete the process. Specifically, having to continue to cook a baked good in order to fully cook the center can result in the edge effects being lost and the edges becoming overcooked which can result in carbonization (blackening) or the edges becoming hard, effectively harming the dish as a whole.

Because of this, there are some pans to try and reduce cooking problems by better distributing batter relative to edges. Basically, these try to position the batter so it is closer to an edge, which increase the speed of heat distribution to the center. A well-known multi-compartment pan is the traditional muffin pan which utilizes a plurality of small individual cups for cooking in. While this type of pan can work well for easing cooking times by having smaller compartments and creating separated goods, it has a few inherent problems including that it can be difficult to get the baked goods out of the cups without use of papers or other liners because of the rigid shape. Further, it can alter the heat profile of the pan due to the dramatically increased surface exposure of the batter to the pan walls resulting in a need to dramatically alter cooking time and/or temperature. Further, the pan is wasteful as much of it is not used and simply acts to connect the individual wells together resulting in a need for the pan to be much larger to hold the same amount of batter. Finally, it can be difficult to evenly fill the individual cups without exterior measurement which can result in products of different sizes and cooking differences between the differently sized products and many people do not want a number of small objects for their baking process.

A second option for baking is to use “edge-making” pans such as that described in U.S. Pat. No. 6,412,402, the entire disclosure of which is herein incorporated by reference. These types of pans use a plurality of internal crests which serve to provide artificial edges inside the pan. Effectively, they simply increase the exterior surface area of the pan without dramatically increasing its footprint to place more batter in closer proximity to an edge. While this can be useful to provide for more edge-effect baking, it has a problem that it only provides a single compartment and is not used to separate goods of slight difference. Further, it's specialized shape means that it is only useful for the specific type of edge baking for which it is designed. In some sense, these pans are simply an extension of a traditional “Bundt” pan which replaces the center of the cake pan with a hole to alter the baking profile in a similar fashion.

Other pans, such as multi-mini and divided cake pans (Such as those made and sold by Alan Silverwood, Limited) can serve to provide for a variety of small mini-dividers within a larger pan. While these resolve many of the problems of a traditional muffin pan, they effectively simply create a specialized muffin pan. One problem with these pans is the need of the pans to provide internal square corners which can make product hard to remove to allow for the dividers to be correctly positioned and separate the compartments. Further, in order for the parts to connect together correctly, the pans only work when all components are integrated and designed to work together. Thus, a consumer cannot utilize existing bake ware they already have with the dividers and are generally forced to purchase a complete pan specific for this use. The pan also will generally not work without all the parts in place.

### SUMMARY OF THE INVENTION

Because of these and other problems in the art, there is a need in the art for a self-supporting baking insert and baking pan which allows for heat to be concentrated at the center of the pan. It is desirable that the insert be useable with a large variety of baking pans and can be used or removed as desired, and which provides for interoperability of parts to provide for flexibility. Such insert will generally be cruciform in shape and self-supporting.

There is described baking pan and insert in combination, the combination comprising: a baking pan having a base and a perimeter wall defining a volume; and a cruciform insert, the insert comprising: at least two wings, each of the wings being a generally flat parallelepiped with a thickness, two edges of a major dimension, two edges of a minor dimension, rounded corners connecting each of the edges of the major dimension to both the edges of the minor dimension and having a slot extending from one of the edges of the major dimension, completely through the thickness, to a distance about half of the minor dimension; wherein at least two of the at least two wings cross generally perpendicularly by inserting the slot of a first of the at least two of the at least two wings into the slot of a second of the at least two of the at least two wings to form a halved joint; wherein, the insert rests on and is not integral with the base of the baking pan in a manner so that one of the two edges of the major dimension of each of the wings is in contact with the base; and wherein, at least a portion of each of the two edges of the minor dimension of each of the at least two wings is within the volume and not in contact with the perimeter wall.

In an embodiment of the combination, the halved joint is located at about a center of the base.

In an embodiment of the combination, the baking pan is a square pan.

In an embodiment of the combination, the first of the at least two of the at least two wings and the second of the at least two of the at least two wings are identical.

In an embodiment of the combination, the baking pan is a round pan.

In an embodiment of the combination, the baking pan is a rectangular pan.

In an embodiment of the combination, the insert is one of two identical inserts placed in the baking pan.

In an embodiment of the combination, the baking pan is a loaf pan.

In an embodiment of the combination, each of the wings comprises food grade stainless steel.

In an embodiment of the combination, the pan comprises food grade stainless steel.

In an embodiment of the combination, the pan comprises glass.

In an embodiment of the combination, the pan comprises aluminum.

In an embodiment of the combination, the wings are coated with a nonstick coating.

### BRIEF DESCRIPTION OF THE DRAWINGS

FIGS. 1A and 1B provide a side and end view of an embodiment of an insert wing.

FIG. 2 provides a side perspective view of an embodiment of crossed insert wings to form a cruciform insert which is in place in a standard loaf pan.

FIG. 3 provides a side perspective view of an embodiment of a cruciform insert in place in a standard 9×9 square pan.

FIG. 4 shows the pan of FIG. 3 with batter placed therein.

FIG. 5 shows the pan of FIG. 4 after baking and with the removal of the insert

FIG. 6 shows an embodiment of a 9×13 pan utilizing two sets of 9×9 inserts.

### DESCRIPTION OF THE PREFERRED EMBODIMENT(S)

Throughout this discussion a number of terms will be used which are intended to have general meanings. For example the term “batter” will be used herein to refer to any food substance which is to be baked, prior to it being baked. While batters are generally considered to be liquid as opposed to dough which is more elastic, the term batter herein is used generally to refer to any form of food material which is to be baked, prior to it being baked. Thus, it is expressly intended to include traditional batters (such as cake batters or brownie batters), dough (such as bread or cookie dough), layers (such as lasagna), foams (such as meringue), or liquids (such as eggs).

Similarly, mathematical terms such as rectangular, square, and round are often used in reference to baking to refer to particular shapes of pans and are often not used with strict mathematical meaning. For example, a round pan may actually be ovular or elliptical, and a square pan may actually be rectangular. Similarly pans will be referred to herein using dimensions such as “9×9” This is generally used to mean the interior dimensions of the base of the pan in inches. However, modern baking pans are often referred to by their size even when it is inaccurate due to vagaries to pan construction. For example a pan a baker would call a “9×9” may actually be as small as 8 inches or as large as 10 inches in a dimension. Thus a “9×9 pan” or similar designation as used herein does not strictly indicate a size, but indicates a type of baking dish which would generally be referred to by that term.

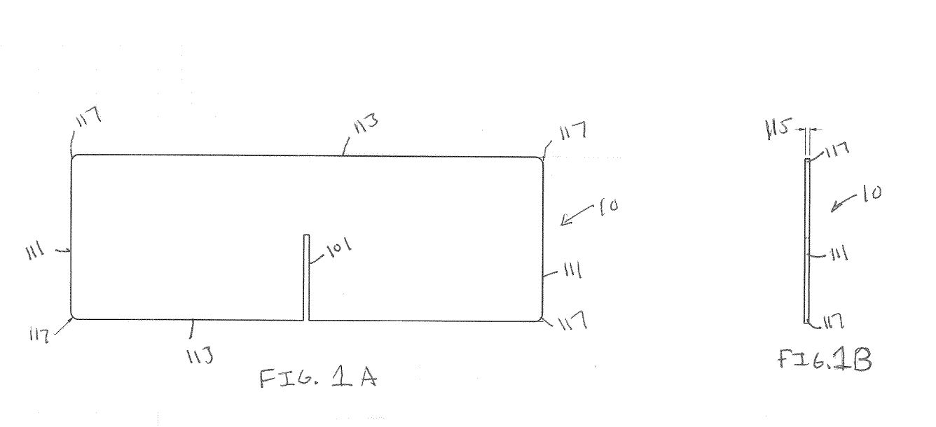

FIGS. 1A and 1B provide an embodiment of an insert wing (10) that can be used with a baking pan. The insert wing (10) is generally parallelepiped in shape with a relatively minimal thickness (115) compared to its major (113) and minor (111) dimensions. It is, thus, generally flat or planar in form and is generally considered to be rectangular. The wing (10) will generally include two minor edges (111), two major edges (113) and a thickness (115). Each of the major edges (113) is connected to both the minor edges (111) via a rounded corner (117). There is a connector slot (101) generally in the center of one of the major edges (113), although alternative and/or additional positions which are not centered can be used in alternative embodiments or to provide additional baking possibilities. However, a center slot (101) is generally preferred as the purpose of the insert wing (10) is to be combined with a second insert wing (10) to form a cruciform insert (100) to be useable with a pan (200) of variable size. The insert (100) will then focus heat in the batter above the approximate center of the base (201) of the pan (200). The slot (101) generally extends about halfway through the wing (10) from the major edge (113) and has an opening thickness that generally corresponds to, and may be slightly larger than, the thickness of the insert wing (10).

The wings (10) will preferably have rounded corners (117) to allow for them to connect in closer proximity to the inside surfaces of baking pans (200). Most baking pans (200) are formed from bent sheet metal or cast glass, and the inside corners (211) which are formed between the base (201) and the perimeter wall (203) are generally not square (“sharp”) but are rounded. While this can provide for easier manufacture in some cases, it also allows for the pan (200) to have certain baking benefits in that there is no place for material to get trapped in a corner, and no point for the collection of baking grease or similar liquid ingredients. Pans (200) will often utilize a perimeter wall (203) arranged at a slight angle with the base (201) so that the volume defined by the perimeter wall (203) and base (201) is generally an inverted pyramid frustum.

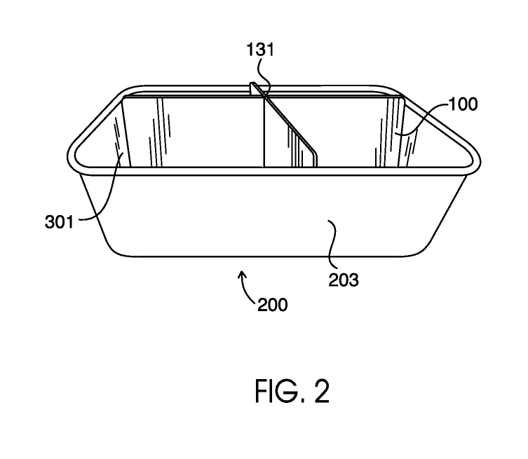

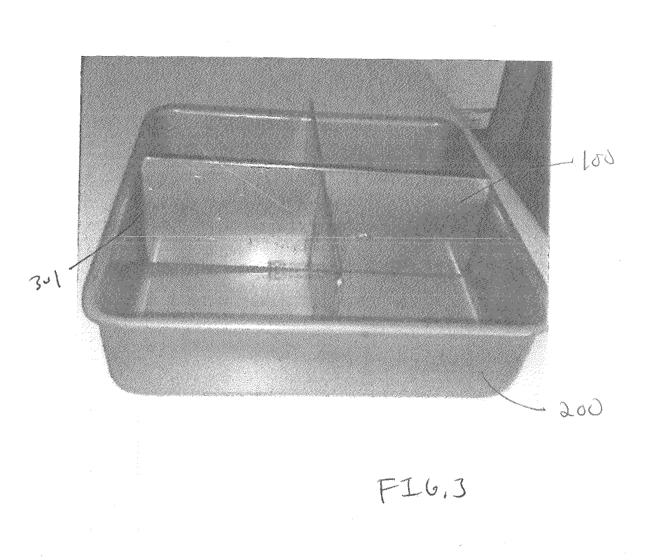

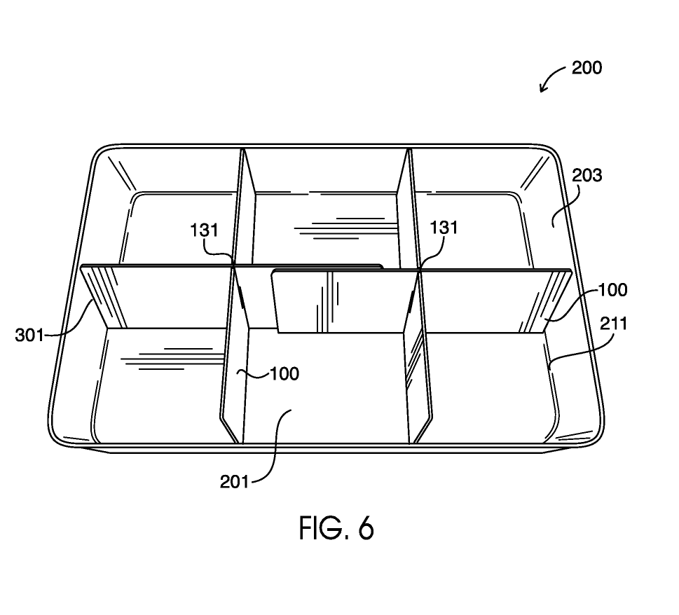

In use, two insert wings (10) will generally be used together in the form of a cross to form a cruciform insert (100). This will be accomplished by turning one wing (10) upside down and sliding the two corresponding slots (101) together in a standard fashion known to those of ordinary skill to form a halved join (131). It is not required that the two wings (10) be the same dimensions, and the wings (10) will generally be chosen to correspond to the dimensions of a pan. Thus a loaf pan (200), which is rectangular, as shown in FIG. 2, will generally utilize two different insert wings (10), while a square pan (200), as shown in FIG. 3, will generally utilize two of the same insert wings (10). Larger pans (200) as shown in FIG. 6, can utilize multiple sets of insert wings (10) and thus multiple inserts (100) which are overlapped. Similarly, a smaller insert (100) (for instance that of FIG. 2) can be used in larger pans (200) (such as that of FIG. 3 or 6). In this case the smaller insert (100) would simply be generally centered in the larger pan (200) (such as by placing the halved join (131) at the center of the pan (200)) or would be placed where heat concentration is otherwise desired.

It should be apparent that the insert wings (10) can generally be freely swapped with each other and components can be interconnected as need be to fit various pans. This provides the wings (10) with flexibility, however, in an alternative embodiment the cruciform insert (100) may be formed as a monolithic piece or utilizing a different manner of assembly. In prior pan dividers, dividers generally had a fixed position relative to each other and had to interface with the pan structure itself in order to work. That is, in order to have a set of dividers to form a cross, the dividers had to be different from each other and were specific to the pan. Otherwise the dividers could not correctly interact with the pan. The present design does not require such interconnection as while the present insert can be used to divide the pan into smaller compartments, it is not primarily designed to produce multiple goods in one pan, it is instead primarily designed to improve center baking Separation of the batter into loose compartments will generally also be accomplished by the present insert, and this can be beneficial in making a variety of different, related, batters simultaneously, but it is not required.

The insert wings (10) will generally have their minor dimension (height) (111) be at least as long as the expected height of the perimeter wall (203) of a standard baking pan (200) and often will be taller. Baking pans (200) are generally made to relatively fixed dimensions and therefore the heights and length of the wings (10) will generally be selected to correspond to this. Thus, in major dimension (113), lengths of just below 4, 5, 8 or 9 inches will be common (as many baking pans utilize these values as at least one of their dimensions), and minor dimensions of 2 or 3 inches will be common (as many baking pans have walls from 1 to 2.5 inches high). For example a wing (10) for use with an 8×8 pan of 2 inch depth may have a major dimension (113) of about 7.5 to 7.9 inches, or about 7.75 to about 7.90 inches, or about 7.88 inches; and a minor dimension (111) of about 2.5 to 3 inches, or about 2.7 to 2.8 inches or about 2.75 inches.

In an embodiment, the wings (10) will be designed to be taller than the sides of the pan. This can provide for preferred operation in that taller wings (10) will generally insure that the batter, if it gets larger during the cooking process, will not flow over the insert (100) or encase the insert (100) as could be the case if the insert (100) was shorter or even with the height of the perimeter wall (203) of the pan (200). This can be particularly important because the halved joint (131) is generally toward the center of the pan (200), and many batters will rise dramatically more at the center than they will at the periphery.

The insert wings (10) can be constructed of any material but are preferably constructed of materials commonly used in baking pans which are conductive. This includes, but is not limited to, metals, stone, and glass. The materials may be coated with non-stick coatings, porcelain, or the like in the same manner as a baking pan as would be understood by one of ordinary skill in the art. In an embodiment, the material used in the wings (10) will be of similar thickness and type of that of the pan (200). Thus, a standard heavy gauge metal baking pan (200) could be used with a wing (10) that is also of heavy gauge metal. In an alternative embodiment, however, the material of the wing (10) is selected to provide for specific effects regardless of the material of the pan (200).

The wing (10) in FIG. 1 may be made of relatively heavy gauge (e.g. about 0.075 inch thick (115)) cooking grade stainless steel sheet. Selection of stainless steel can provide for certain benefits in conjunction with a variety of pans (200). In the first instance, it is generally preferred that the insert wing (10) be quite heavy. In this way, when the insert (100) is set in the pan (200), even a relatively thick or elastic batter cannot cause the insert (100) to “float” upward in the batter. Most adjustable or mini pans utilize a divider which is made of light gauge aluminum which is the same material as the pan itself and is inexpensive and thin. This is because these are dividers designed to break the pan into smaller compartments and they interconnect directly with the pan itself.

Further, the present insert (100) is intended to primarily be used as a heat focus to improve center cooking, as opposed to creating additional edge effect baking or multiple product compartments. Stainless steel is generally a relatively poor heat conductor compared to other materials commonly used in baking pans, however, it is still quite common in the construction of baking pans and provides very even heating, particularly when thicker. By utilizing stainless steel in the construction of the insert (100), the insert will generally be a conductor which is no better at conducting than the material of the pan (200) (as aluminum and glass are generally better conductors).

This means that the insert (100) will sometimes provide an additional “edge” internal the volume of the pan (200), but will often, instead, provide a conductive heat focus worse than the conduction of the perimeter wall (203). In this way, the insert (100) will serve to assist in baking the center of the batter, but will not truly subdivide the batter into multiple small “compartment” pans. That is, it is not necessarily a true edge. This effect is further indicated by the fact that the minor edges (111) of the insert (100) need to be in contact with the perimeter wall (203) of the pan (200) as discussed in greater detail later.

Stainless steel is a conductor and can provide heat to the center of the batter that otherwise is not present. When a divider is used which is the same conductor as the pan, it can create additional edge effects which can still leave the center of each compartment relatively unbaked and can require significant time and temperature alteration during baking to get correct doneness. This can accelerate cooking (by making the distance of heat transfer to the center of each compartment smaller than that of the pan as a whole) and results in a pan which is effectively a muffin pan. However, in many cases, the center divider actually only acts as a divider and has little to no effect on heat transfer. A slightly poorer conducting material which is not a true edge can provide some additional heat directly to the core of the batter, without actually making the pan behave like multiple small pans and thus can result in better baking (and better edge effects) without radical alteration of time and temperature.

As indicated above, FIGS. 2 and 3 show various cruciform inserts (100) in place in two different pans (200), both a standard loaf pan (FIG. 2) and a standard square pan (FIG. 3). The loaf pan (200) utilizes an insert (100) formed from two insert wings (10) of different major dimension (113) but the same minor dimension (111) and thickness (115), while the square pan uses two insert wings (10) of generally identical dimensions. As can be seen from the FIGS, the insert (100) is freestanding and arranged generally with the halved joint (131) in the center of the base (201).

While the minor edges (111) of the insert (100) will generally contact the inner surface of the perimeter walls (203), the minor edges (111) will generally will not be flush with the perimeter walls (203) and there is a clear gap (301) between at least one point of the minor edge (111) and the perimeter wall (203) inside the volume defined by the base (201) and perimeter wall (203). This is particularly true at higher vertical positions if the walls of the pan (200) are inclined.

This type of imperfect (or in effect non-existent) connection between the minor edge (111) and the perimeter wall (203) can provide for a number of benefits. For one, it is important to recognize that the insert (100) will have different heat exposure to heat in the oven. In particular, while the perimeter (203) of the pan (200) has one of its major faces in contact with the heat in the oven and one in contact with the batter, the batter will generally be on both sides of each insert wing (10) and proximity of the batter to a greater surface area dramatically increases the closer the batter is to the halved join (131).

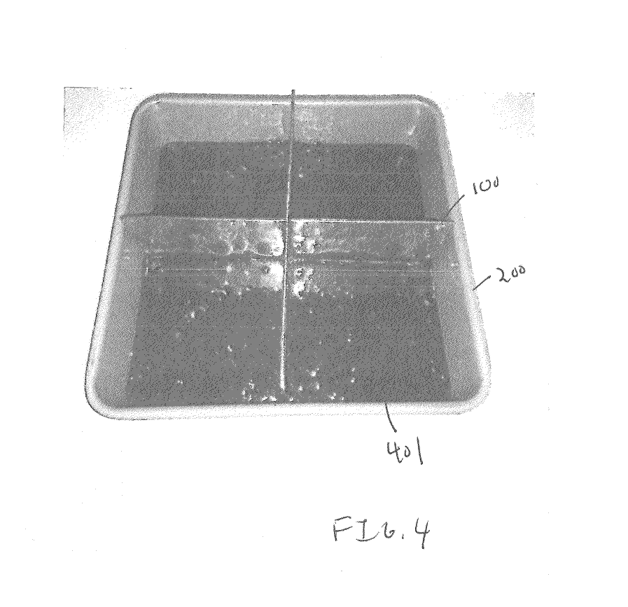

In order to allow the insert (100) to conduct heat, it is therefore desirable that the insert (100) extend a significant distance above the batter which is placed in the pan (200), at least when baking begins. This dramatically increases the surface area of each wing (10) exposed to the ambient heat of the oven and allows the insert (100) to heat up faster and transfer heat to the batter. As such, it allows for heat to be pulled generally into the center of the pan (200) where the cruciform shape of the insert (100) dramatically increases the amount of heat which can be transferred to the batter. This is best shown in FIG. 4 where a brownie batter (401) has been placed in the pan.

As can be seen in FIG. 4, the batter (401) will generally be distributed evenly within the pan (200). Depending on the batter (401) and any secondary effects of the insert (100), this can influence how and when the insert (100) is placed in the pan (200). In certain embodiments, such as if the insert (100) is being used to subdivide a baking area to make slightly different products in addition to its heating effects (such as to make an egg bake with and without ham in certain sections) the insert (100) may be present when the batter (200) is added to the pan. This can allow for different batters to be used in the different compartments while still allowing the batter (401) to generally flow around the insert (100) if it is sufficiently liquid. However, in many situations, it may be preferable for a base batter (in the case of an egg bake, this being the egg component) to be added to the container prior to the insert (100) being positioned.

Most batters (401) are somewhat flowable. As such, if placed in the pan (200) they will generally reach an equilibrium when most of the batter (401) is at similar depth. This can encourage even baking By placing the batter (401) in the pan (200) and then placing the insert (100), this equilibrium can be easily obtained. The insert (100) can then be positioned into the pan (200) to split the batter (401) into the various compartments. This can be used if the insert (100) is only being used to provide for heat focusing, or can also be used if a core batter (e.g. the above referenced egg in an egg bake) is being used with multiple different add-ins. Specifically, ham can be added to one section but not the other.

An advantage of allowing the insert (100) to be placed after the core batter (401) is added to the pan (200) is that the baker need not worry if each compartment is filled the same amount. Further, the imperfect connection between the minor edges (111) and the perimeter walls (203) of the pan (200) allows for particularly flowable batters to flow between compartments, while still keeping add-ins (which are often chunky or significantly less flowable than the core batter) in the requisite compartment(s).

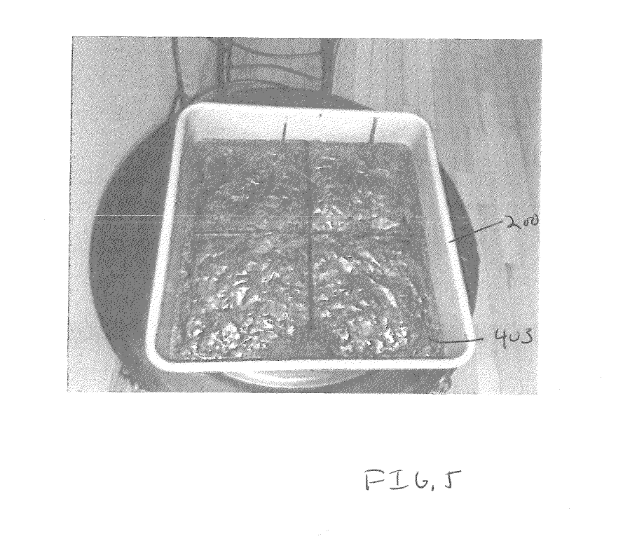

FIG. 5 provides for the pan (200) of FIG. 4 after the batter (401) has been baked and the insert (100) removed. As can be seen, the resultant baked good (brownie) (403) still bears lines where the insert (100) was placed, however, the brownie (403) is a coherent whole and may be served from the pan (200) directly. Thus, while the insert allowed for heat to be concentrated in the center of the pan (200), the pan (200) has effectively made only one pan of brownies (403) as opposed to four separate pans. Thus, should it be desirable to utilize the pan (200) in a traditional fashion (e.g. to be frosted and cut into squares), the pan (200) can be treated, in many respects, the same way as if the insert (100) wasn't used. However, the position of the insert (100) can also be used as an initial cut to allow the brownie (401) to be readily made into smaller pieces, if desired.

FIG. 6 shows the advantage of not having to utilize the insert in a particular fixed pan and the fact that single sized insert wings (10) can be used in multiple embodiments. Most baking “rectangle” (that is as opposed to round or fancy shaped) pans utilize one dimension that is either 8″ or 9″ For example, 8×4, 9×5 8×8, 9×9, and 9×13 pans are all common sizes. A variety of heights are used, but in many cases the heights are not relevant to pan selection. Baking directions for boxed mixes generally comport with these shapes and provide recipes for such common baking pans. Having the insert (100) be designed to fit in these common dimensions allows for a large variety of use. Specifically, the insert (100) can come in 8 or 9 inch major dimensions and 4 or 5 inch major dimensions. With a section of only these two sized pieces, an insert (100) to subdivide virtually any sized “rectangular” pan is possible. Specifically, as shown in FIG. 6, two 9×9 inserts (100) can be used to subdivide a 9×13 pan into six compartments by simply overlapping two of the insert wings (10). As the wings (10) are relatively thin compared to the other dimensions, this double thickness will generally have minimal effect on heat transfer.

It should also be apparent that the use of two inserts (100) where the halved joints (131) are not actually centered in the pan, can actually improve the cooking process by placing the centers of each “compartment” of the result pan at a more generally equidistance from the perimeter wall (203). In effect, by placing the inserts (100) so that all the resultant compartments are more square than the underlying pan (200), heat can be better distributed to the batter at all points.

Because there is no need for the minor edge (111) of the insert (100) to interface with the perimeter wall (203) directly, the insert (100) can be used with a large number of pans (200) of different shapes and sizes. For example a 9×9 cruciform insert (100) can be used in a 9 inch diameter round pan, and a 9×5 loaf pan insert (100) can be used in a 9 inch tall heart shaped pan. As there is no requirement that the insert (100) contact the perimeter wall (203) at any point, the insert (100) is useable in a wide variety of situations with relatively minimal components. It is envisaged, in an embodiment, that the wings (10) can be provided as sets having only two pieces each of two identical dimensions. A core set could be designed to fit a 9×9 pan. An add on set could then supply two 5 inch major dimension (113) pieces so that in combination with the original set the pieces can be used in two 9×5 loaf pans or the above indicated 9×9. It should be readily apparent that with only these two sizes of wings (10), with sufficient numbers of wings (10) inserts (100) can be made which will fit virtually any standard size pan (200).

The advantages of the insert (100) are therefore multi-fold. In the first instance, the insert (100) is generally not limited to use with a particular pan (200). Prior divided pans generally required the presence of square internal corners to allow for the components to fit tightly together and actually subdivide the pan into separate compartments. Further, as contemplated above, having the insert (100) be taller than the perimeter wall (203) of the pan (200) can allow for improved heating of the insert (100) when there is batter on both sides of the insert (100) and keep the insert from being difficult to remove. Finally, by having the insert (100) be loose and have an imperfect fit, the insert (100) can be added to the pan (200) after the batter (401) has been placed in the pan (200) and allowed to self-level, and the insert (100) can be removed from the pan (200) without removing the resultant baked good (403).

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A baking pan and insert in combination, the combination comprising:
a baking pan having a base and a perimeter wall defining a volume; and
a cruciform insert, said insert comprising:
at least two wings, each of said wings being a generally flat parallelepiped with a thickness, two edges of a major dimension, two edges of a minor dimension, rounded corners connecting each of said edges of said major dimension to both said edges of said minor dimension and having a slot extending from one of said edges of said major dimension, completely through said thickness, to a distance about half of said minor dimension;
wherein at least two of said at least two wings cross generally perpendicularly by inserting said slot of a first of said at least two of said at least two wings into said slot of a second of said at least two of said at least two wings to form a halved joint;
wherein, said insert rests on and is not integral with said base of said baking pan in a manner so that one of said two edges of said major dimension of each of said wings is in contact with said base; and
wherein, at least a portion of each of said two edges of said minor dimension of each of said at least two wings is within said volume and not in contact with said perimeter wall.

2. The combination of claim 1 wherein said halved joint is located at about a center of said base.

3. The combination of claim 1 wherein said baking pan is a square pan.

4. The combination of claim 3 wherein said first of said at least two of said at least two wings and said second of said at least two of said at least two wings are identical.

5. The combination of claim 1 wherein said baking pan is a round pan.

6. The combination of claim 1 wherein said baking pan is a rectangular pan.

7. The combination of claim 6 wherein said insert is one of two identical inserts placed in said baking pan.

8. The combination of claim 1 wherein said baking pan is a loaf pan.

9. The combination of claim 1 wherein each of said wings comprises food grade stainless steel.

10. The combination of claim 9 wherein said pan comprises food grade stainless steel.

11. The combination of claim 9 wherein said pan comprises glass.

12. The combination of claim 9 wherein said pan comprises aluminum.

13. The combination of claim 1 wherein said wings are coated with a nonstick coating.
